(19) United States
(12) Patent Application Publication
(10) Pub. No.: US 2017/0243125 A1
(43) Pub. Date: Aug. 24, 2017

(54) BAYESIAN CLASSIFICATION ALGORITHM MODIFICATION FOR SENTIMENT ESTIMATION

(71) Applicant: Sprinklr, Inc., New York, NY (US)

(72) Inventors: Ragy Thomas, New York, NY (US); Murali Swaminathan, New York, NY (US); Xin Feng, New York, NY (US)

(21) Appl. No.: 15/052,278

(22) Filed: Feb. 24, 2016

(51) Int. Cl. G06N 5/04; G06F 17/28; G06N 7/00

(52) U.S. Cl. CPC G06N 5/048; G06N 7/005; G06F 17/28

(57) ABSTRACT

Systems and methods that enable usage of a modified Bayesian classification to enable sentiment estimation in social media. In some embodiments, events are classified, and the words described sequentially to the event are processed. The system processes historical information and current information to identify the most likely subclass a document belongs to, to help in the estimation of sentiment of a social media user.

### FIELD OF THE INVENTION

The present invention relates to systems and methods for utilizing social media data for processing user sentiment.

### BACKGROUND OF THE INVENTION

A tremendous amount of information is embedded inside social media data and it is extremely important for companies to utilize this information to track conversations about their brand, to engage with their customers, to conduct advisement and investment efficiency analysis, to manage and reduce potential risk and identify the factors that affect company sale and revenues.

It will be beneficial to have a system and method for estimating of end user sentiment from massive social media data.

### BRIEF DESCRIPTION OF THE DRAWINGS

The accompanying drawings illustrate one or more exemplary embodiments and, together with the detailed description, serve to explain the principles and exemplary implementations of the present inventions. One of skill in the art will understand that the drawings are provided for purposes of example only.

FIG. 1 is a flow chart diagram of a social media data collection method, in accordance with some embodiments of the present invention:

FIG. 2 is a flow chart diagram of a user sentiment detection system and method, in accordance with some embodiments of the present invention: and

FIGS. 3A-3B are a flow chart diagram of a Message Processing method in accordance with some embodiments of the present invention.

### DETAILED DESCRIPTION OF THE PRESENT INVENTION

Various exemplary embodiments of the present inventions are described herein in the context of systems and methods for utilizing social media data for processing user sentiment. Those of ordinary skill in the art will understand that the following detailed description is illustrative only and is not intended to be limiting. Other embodiments will readily suggest themselves to such skilled persons having the benefit of this disclosure, in light of what is known in the relevant arts.

In the interest of clarity, not all of the routine features of the exemplary implementations are shown and described. It will be appreciated that in the development of any such actual implementation, numerous implementation-specific decisions must be made in order to achieve the specific goals of the developer. Throughout the present disclosure, relevant terms are to be understood consistently with their typical meanings established in the relevant art.

The method and system is to provide for automated identification, analysis and use of available social media data to help companies enhance revenue generation and business decision making by running a process to identify user sentiment can be enabled by data processing algorithms that integrate modified Bayesian classification methods. While the underlying mathematical theory used herein is similar to Vector space and Bayesian statistics analysis, the way system and methods in which these theories are being applied herein are novel in terms of parameters derivation, data manipulation and iteration criteria. The system described herein incorporates AI and generic algorithms into existing vector space and Bayesian analysis, thereby changing both the process and the results.

The user sentiment identification and analysis is executed using a computer code (for example, a computer program which is written using C#) running on a server (for example, window server 2008) a connected to a data cloud (for example, Amazon servers cloud). There are multiple physical servers running on the cloud on a cluster system behind a load balancer. The load balancer is configured to receive huge numbers (example, millions per second) of social media data items that are downloaded every minute, and to distribute the data to one of the servers in the cluster system. The sentiment identification system on the server analyzes the data and derives a user sentiment value. In some embodiments, the sentiment output may include multiple categories, typically but not always represented by a set of integers. One example is depicted in the following table.

| Integer value | Meaning |
|---|---|
| 2 | Strong positive |
| 1 | Positive |
| 0 | Neutral |
| −1 | Negative |
| −2 | Strong negative |

Table 1 shows an example of sentiment output integer's and their meaning.

Further, embodiments of the sentiment identification system described herein may be used to calculate a numeric value to represent user sentiment, for example, when exposed to one or more products from a brand. This is an extremely important data for organizations to know, for example, to implement:
Business activity planning
Material purchasing
Target advertisement and increasing sales
Product improvement
Customer relation management
Companies can use this data as an independent variable to identify whether age, gender, incoming, region, ethic group and other social groups has a preference for their product
Risk management

Thus, in the following, systems and methods are disclosed that enable usage of data embedded inside social media data, thereby to allow companies or organizations to utilize this information to track conversations about their brand, to engage with their customers/users, to conduct advisement and investment efficiency analysis, to manage and reduce potential risk, and identify the factors that affect company sales and revenues.

In the preferred embodiments, methods are provided for substantially automated identification and analysis of user sentiment based on social media interactions.

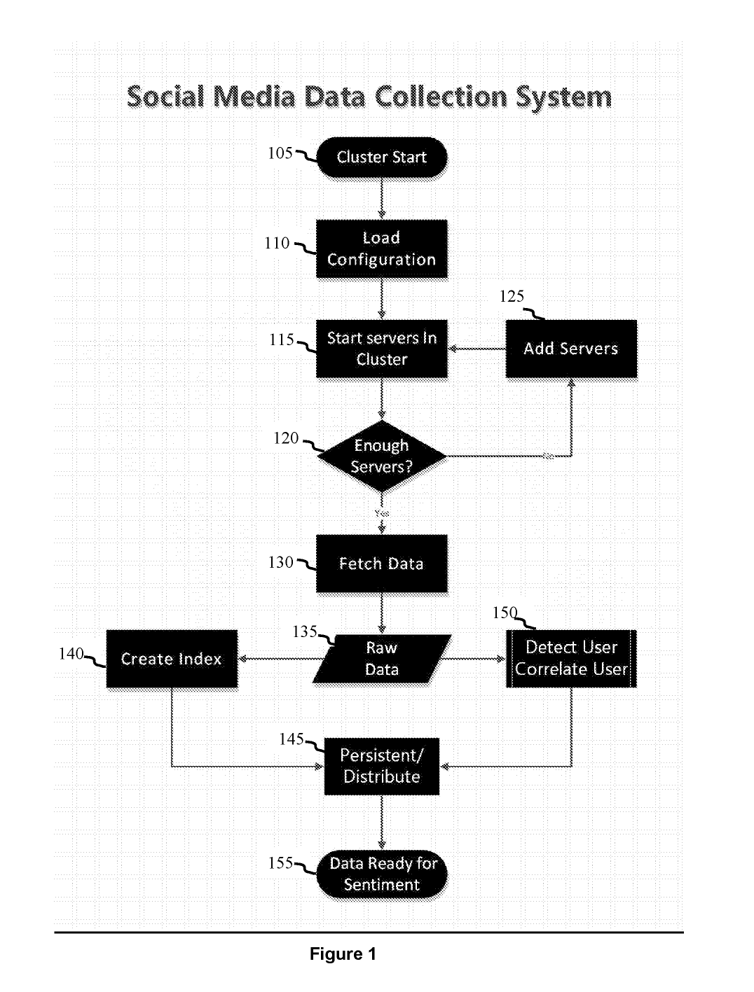

In FIG. 1, which is a flow chart diagram of a social media data collection method, the “Social Media Data Collection System” 100 is a server side component (process) which is deployed across many servers over the cloud. The major functionalities for this system 100 include fetching/collecting data from social media networks, for example, Face Book, Twitter, Renren, Sina Weibo, Wechat, Linkedin and many other blog and many other web sites. The number of servers used for data collection is based on the system configuration. If there are more companies, more customer accounts, or more keywords to search on web sites, the system 100 is enabled to dynamically deploy more servers across the cloud.

In FIG. 1, in step 105 a clustering of servers is initiated to handle the organization of available data into manageable and linked groups over a distributed network, by Social Media Data Collection System 100.

In step 110 a pre-defined configuration is loaded into the cluster that has been started to enable the clustering and capability establishment of the server cluster established at step 105 to perform the necessary functions for data collection and organization. The configuration also enables the cluster of servers to assess its own capacity to handle the data volume and dynamically set the cluster size.

In step 115 servers of the cluster of servers are started, to enable the collected data to be processed and the collected data is made ready to be provided to configured servers within the system 100.

In step 120 a decision is taken as to whether there are enough servers in the cluster to process the collected data. If not, at step 125 additional server(s) are added to the server cluster.

If there are enough servers at step 120, collected data is fetched in step 130, from multiple social media sources, in multiple data formats.

In step 135 the raw data from various sources is aggregated, to be further processed.

In step 140 an index is created of the raw data, for enabling rapid categorization, sorting, fileting and searching of the raw social media data.

In step 150 the raw data is processed by an algorithm to detect the specific user(s), and to correlate detected user(s) to the user profiles in the Social Media Data Collection System 100.

In step 145 the indexed and/or user correlated data is further processed to determine whether the collected data is to be persisted/maintained in the system 100, or is only to be distributed to system components for access by user(s). If the data is to be persisted, then the data at each stage is saved in containers.

In step 155 the processed data is now fed to a further sentiment processing engine or element, for Sentiment specific analyzing, to detect user Sentiment.

The social media collection system 100 includes many data processing systems, which will all consume data from a specific container or many containers simultaneously from the distributed network cache, and push the analyzed results to one or more additional containers on the distributed network.

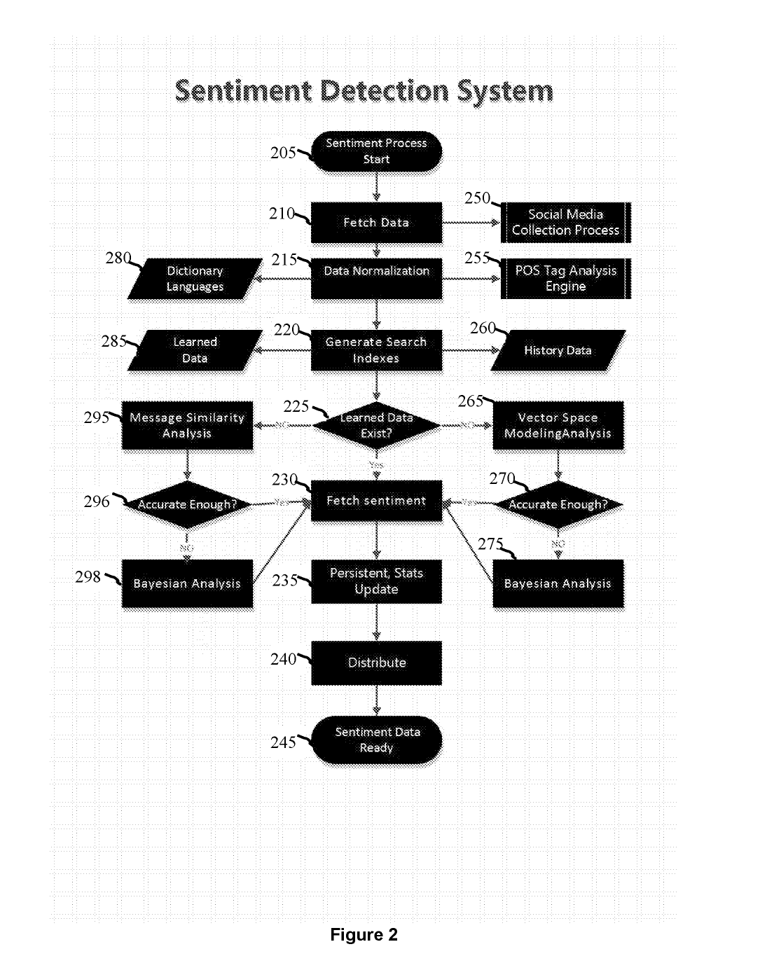

In the embodiment illustrated in FIG. 2, Sentiment detection is one of the parts of the user sentiment analysis process. The system 100 may include many independent processes that all pull messages from one or more containers in a distributed network repository. The flow chart in FIG. 2 describes some major elements and their interaction in the sentiment detection system 200.

In preferred practice, the collected data from multiple sources is supplied to a computational-capable server having at least a processor and at least a storage capability. The initially collected data is used to teach the processor to analyze the available data. Once taught, additional data is provided to the server to generate a rating of the sentiment of the user(s). For example, there are many millions of messages collected in the system per hour or even second, and the number is continually growing daily as more customers, accounts and different search criteria and interests are entered. The system's 100 servers may be deployed in a cluster with virtually unlimited computing power. This process is dynamic in that more servers can be added automatically if needed based on the volume of data being analyzed.

In FIG. 2, a work flow an example of a “Sentiment Detection System” 200 is described. It has two functional sets of steps, one set is a learning process and the other the use of the learning to convert the data into usable form and extract the sentiment there from.

In step 205, the first functional steps to Sentiment Detection process is started by the Social Media Data Collection System 100.

In step 210 data is fetched from multiple social media sources, and in step 250, the fetched social media data is collected together in the system data storage facilities distributed over the network.

In step 215 the data is normalized, to convert all received data into a unified format, by the processing capability of the system data converter element.

In step 280 the data is processed using a dictionary, optionally with multiple languages, to further normalize data from multiple languages.

In step 255 the data is further processed using a POS tag Analysis Engine, to identify critical POS sale data.

In step 220 search indexes are generated, to help rapidly search and sort collected data.

In step 260 data history is used to help optimize the search indexes.

In step 285 learned data is further updated, using the search indexes and/or historical data.

In step 225 the system determines whether the learned data is sufficient to establish accurate search indexes.

If not enough learned data exists, then in step 265 vector space modeling analysis may be executed, to further process collected data, to complement the accuracy of the learned data.

Additionally or alternatively, in step 295 message similarity analysis is executed, to further process collected data, to complement the accuracy of the learned data.

If learned data is found to be sufficient, then in step 230 additional Sentiment related data to be analyzed, is fetched and created into a file, for example, including data source, time, brand, product, sentiment score, user information, influence weight, or other examples of sentiment related factors.

In step 296 a decision is taken by the system as to whether the sentiment information derived is accurate enough.

If not, in step 298, Bayesian analysis is executed on the processed sentiment data to establish sentiment accuracy.

Alternatively or additionally, if the derived data is accurate, in step 235, if the data is persistent, the system sentiment statistics are updated, to include the latest sentiment definitions, classifications, etc.

In step 240 the processed sentiment data as determined by the above steps is distributed to the system's servers, for distributions to system elements or components.

In step 245, the distributed sentiment data is ready for usage by system users.

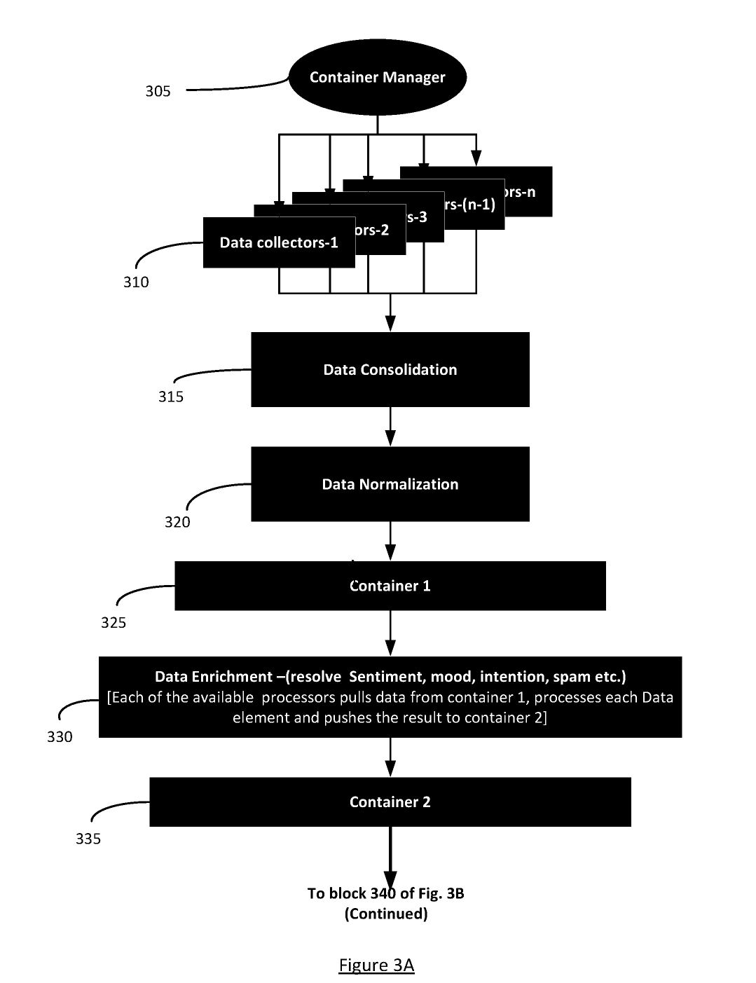

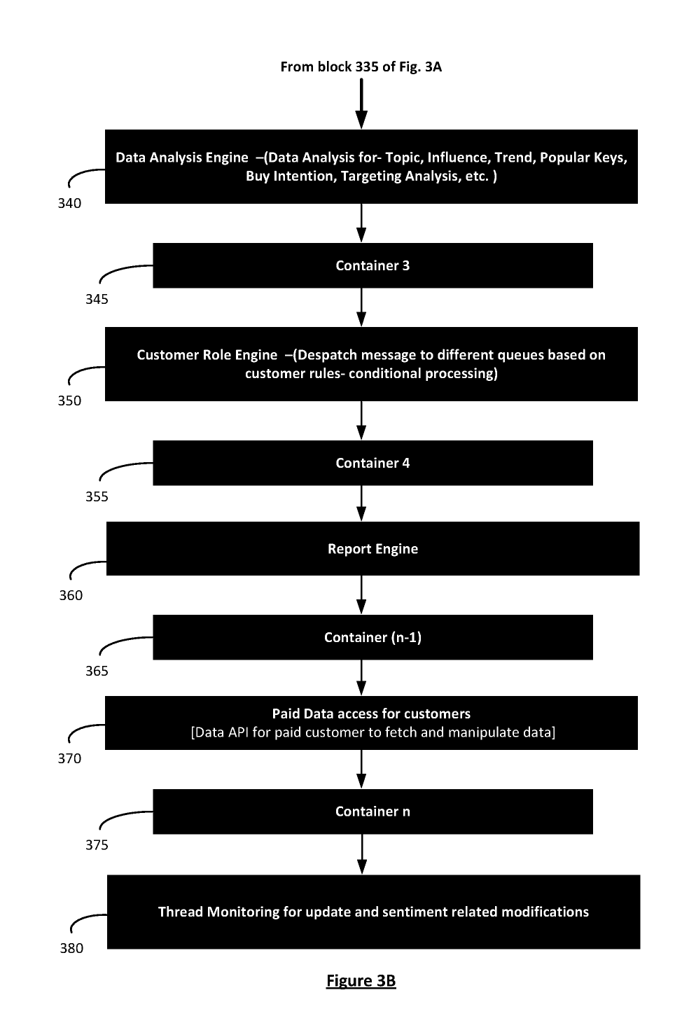

FIGS. 3A and 3B are a 2-part flow chart diagram of a Message Processing Method, in accordance with some embodiments, that illustrate elements in the system's message system, to convey a part of the functionality being described herein. The system may have many servers on a cloud that collect data from social media. The collected data is put into a virtual location or processor, referred to hereinafter as a “container” of a network distributed cache. Many processes can concurrently access the same container at any time. Each process can pull one message a time and process it, and may push the modified data into another container. A user can create any number of containers at run time. The system also enables many processes to work similarly, whereby the number processes run in the system is dependent on the system configuration. For example, a user may configure from 1 to hundreds, thousands or more processes at will. Of course, more processes may require more computing power.

In step 310, the collected social media data is sent to multiple data collectors 1 to n.

In step 315 the data collectors data is consolidated, for example, collected from different sources into system data collectors.

In step 320 the data is normalized, for example, to aggregate different formats and types of data.

As can be seen, in step 325 multiple processors are used to pull sentiment related data from a container(s) and to further process one or more data elements, and then push the resultant processed data elements to a further data container.

In step 330 data enrichment is executed, optionally including processing the pre-processed data for sentiment related information.

In step 335, container 2 may be further processed by Social Media Data Collection System 100.

In step 340 a data analysis engine processes container data for further sentiment related metrics, such as brand attitudes, loyalty, experience and/or other sentiment related factors.

In step 345 container 3 may be further processed by Social Media Data Collection System 100.

In step 350 a customer role engine dispatches the message to different queues based on system requirements, such as customer rules, conditional processing etc.

In step 355 container 4 may be processed by Social Media Data Collection System 100.

In step 360 a report engine processes the data to generate sentiment related reports.

In step 365 container x is processed by Social Media Data Collection System 100.

In step 370 a data API for paid customers is run, to manipulate and fetch data for advanced features or functions as may be used by paid users.

In step 375 container n is processed by Social Media Data Collection System 100.

In step 380 thread updates are monitored to determine sentiment related modifications in data threads, for example, from discussions regarding a brand, product, idea etc. in real time between multiple people over social media, where different people discuss different things. Therefore, multiple threads, for example discussions on quality, price, sentiment, purchase incentive etc., may be interlinked. In the case of extracting the sentiment, the related threads may be followed and collected for processing.

The system described herein may have many servers on a cloud that collect data from social media. The collected data is put into a container of a network distributed cache. Many processes can concurrently access same container at any time. Each process can pull one message a time and process it, and may push the modified data into another container. A user can create any number of containers at run time. The system also enables many processes to work similarly, whereby the number processes run in the system is dependent on the system configuration. For example, a user may configure from 1 to hundreds, thousands or more processes at will. Of course, more processes may require more computing power.

Embodiments of the present invention may include a combination of one or more of the following elements:
Combine user social media data from multiple source (FB, Twitter, Linkedin, Renren, Sina weibo,Tencent wechat etc.) to estimate user sentiment.
Grading social data for sentiment identification.
Feeding data into the system for AI and Bayesian learning for sentiment identification.
Estimating sentiment identification using a combination of first direct matching, Vector Space analysis, POS tag analysis and message replacement, and then Bayesian statistics.
Utilizing sentiment identification scores to identify potential buyers.
Utilizing sentiment identification scores to Identify positive and negative influencers.
Utilizing sentiment identification scores to estimate advertising efficiency.
Utilizing sentiment identification score to estimate parameters for targeted fixed effects like gender, age, education, income, region, search history and purchase patterns.
Utilizing sentiment identification scores to identify potential buyers' common properties.
Utilizing sentiment identification scores to trace stimulate factors for potential buyer status change.

According to some embodiments of the present invention, two discrete events may be defined. One event is the classification of an event, and another event is the analysis of the words appearing sequentially to the event in a document. Embodiments can utilize historical data from historical user social media engagement, as well as data from current documentation or sources, to identify the most likely subclass this document belong to.

$$P ( {C}_{i} \vert W ) = \frac{P ( W \vert {C}_{i} )}{P ( W )}$$

Where Cᵢ represents different subclass. Since only the relative value is required, thus the P(W) can be ignored for simplicity.

$$\frac{P ( {C}_{i} \vert W )}{P ( {C}_{j} \vert W )} = \frac{P ( W \vert {C}_{i} )}{P ( W \vert {C}_{j} )} = \frac{P ( {W}_{1} ⋂ {W}_{2} ⋂ … ⋂ {W}_{n} \vert {C}_{i} )}{P ( {W}_{1} ⋂ {W}_{2} ⋂ … ⋂ {W}_{n} \vert {C}_{j} )}$$

According to the Chain rule:

$$P ( {W}_{1} ⋂ {W}_{2} ⋂ … ⋂ {W}_{n} ) = P ( {W}_{1} ) P ( {W}_{2} \vert {W}_{1} ) P ( {W}_{3} \vert {W}_{1} ⋂ {W}_{2} … P ( {W}_{n} {⋂}_{i = 1}^{n - 1} {W}_{i} )$$

From the above formula, it can be seen that there is a need to collect information for each subclass that has been defined. For example, if sentiment data is used as an example of classification, 5 subclasses (strong negative, negative, neutral, positive and strong positive) may be required. For example, i=1 to 5 may be used to represent these subclasses respectively.

Since a set of graded data is required, this set of graded data may be split into two subsets. One subset of data may be used for training the classification engine and the other subset to evaluate the accuracy of classification. For example, if there is 100 k data lines (documents) and this is split into two subset randomly, each subset has 50K documents. The first set may be labeled as a “training set” and a second set as a “test set”.

In the training set, there may be a similar observation ratio as in real population. For example, if sentiment training is used as an example, strong positive is on average 5% of whole documents, so 50 k*0.05=2.5K, which may be considered a strong positive in the training set. This number is not absolute, just a guide line.

So for each subclass, the following information may be collected:
Wᵢ
WᵢWᵢ₊₁
WᵢWᵢ₊₁Wᵢ₊₂
WᵢWᵢ₋₁Wᵢ₊₂Wᵢ₊₃
WᵢWᵢ₋₁Wᵢ₊₂Wᵢ₊₃Wᵢ₊₄
WᵢWᵢ₊₁Wᵢ₊₂Wᵢ₊₃Wᵢ₊₄ . . . Wᵢ₋ₙ

After collecting all relevant phrases, there normally is enough necessary information to calculate corresponding relative probability.

First: Parsing the incoming message into words list, which includes all punctuation.

Then collecting one word as a probability of the current message:

$${\sum }_{i = 1}^{n} P ( {W}_{i} ) = {\sum }_{i = 1}^{n} {W}_{i} \text{/} S$$

$$S = {\sum }_{i = 1}^{w} {C}_{i}$$

W is the number single word existed in system, Cᵢ is total count for Wᵢ.

After done for single word, a run can be executed on a two words combination:

$$2 {\sum }_{i = 1}^{n - 1} P ( {W}_{i} ⋂ {W}_{i + 1} ) = {\sum }_{i = 1}^{n - 1} {C}_{{w}_{i} {w}_{i + 1}} \text{/} {S}_{2}$$

Where S₂ is total two-word appearances as counted in the system.

For a 3 words combination:

$$4 {\sum }_{i = 1}^{n - 2} P ( {W}_{i} ⋂ {W}_{i + 1} ⋂ {W}_{i + 2} ) = {\sum }_{i = 1}^{n - 1} {C}_{{w}_{i} {w}_{i + 1} {w}_{i + 2}} \text{/} {S}_{3} .$$

It should be noted that the coefficient in front of the summation is equal 2^{m-1} where m is the words in combination.

In general, the formula may be defined as follows:

$${2}^{m - 1} {\sum }_{i = 1}^{n - m} P ( {W}_{i} ⋂ {W}_{i + 1} ⋂ {W}_{i + 2} … {⋂}_{i + m} ) = {\sum }_{i = 1}^{n - 1} {C}_{{w}_{i} {w}_{i + 1} … {w}_{m}} \text{/} {S}_{m}$$

In practice, the word list may be looped through. For each position I, most n-I+1 words may be combined, but usually it is interrupted in relative lower number of case.

For example, if there is a sentence like “I loved this good book and read it from cover to cover in one afternoon.”

After partition, there is a word list of 16 words (included the “.”);

Double whole=0.0;
For( i=0;i<16;i++)
{
Double positionsum=0;
Positionsum+=one word probability
Positionsum+=2*2- word probability
Positionsum+=4*3- word probability
...
Whole+= Positionsum;
}.

### Vector Space Model and Messages Similarity Calculation:

The vector space model is widely used for related documents retrieval and messages similarity calculation mainly because of its conceptual simplicity and the appeal of the underlying metaphor of using spatial proximity for semantic proximity. Vector space model treats message as a point in an n-dimensional spaces where n is the number of common words in the two messages or message and a category. The coordinators of given message and group are calculated based word frequency occurred in message and group of messages. The similarity coefficient is usually expressed as vectors normalized correlation coefficient as follow:

$$cos ( g , m ) = \frac{{\sum }_{i = 1}^{n} {g}_{i} {m}_{i}}{\sqrt{{\sum }_{i = 1}^{n} {g}_{i}^{2}} \sqrt{{\sum }_{i = 1}^{n} {m}_{i}^{2}}}$$

Where gᵢ is i'th word frequency for one of learned categories and mᵢ is the i'th word frequency for current message. The advantage of vector space model is that it uses little computer memory and computing algorithm is simple and direct. The disadvantage is that it does not use other information like word order, word combinations, word meaning and AI technology.

At this juncture, it can be appreciated that the calculated sentiment analysis can be used for several purposes. For instance:

1. Utilizing sentiment identification scores to identify potential buyers.

2. Utilizing sentiment identification scores to identify positive and negative influencers.

3. Utilizing sentiment identification scores to estimate advertising efficiency.

4. Utilizing sentiment identification score to estimate parameters for targeted fixed effects like gender, age, education, income, region, search history and purchase patterns.

5. Utilizing sentiment identification score to identify potential buyer's common properties.

6. Utilizing sentiment identification score to trace stimulate factors for potential buyer status changes.

The preceding has described systems and methods with reference to specific configurations. These foregoing descriptions of specific embodiments and examples have been presented for the purpose of illustration and description only, and although the invention has been illustrated by certain of the preceding examples, it is not to be construed as being limited thereby.

What is claimed is:

1. A method for using social media data, from multiple sources, by usage of a modified Bayesian classification to enable sentiment estimation of the users of the social media, the method comprising the steps of:
a) defining two discrete events, one of the events being the classification of an event, and another event being analysis of the words appearing sequentially to the event in a document;
b) in the analysis of the words appearing sequentially to the event in a document, parsing the incoming message into words list, which includes all punctuation;
c) then collecting one word as a probability of the current message:
$${\sum }_{i = 1}^{n} P ( {W}_{i} ) = {\sum }_{i = 1}^{n} {W}_{i} \text{/} S$$
$$S = {\sum }_{i = 1}^{w} {C}_{i}$$
where, W is the number single word existed in system, and Cᵢ is total count for Wᵢ.

2. A method for using social media data, from multiple sources, by usage of a modified Bayesian classification to enable sentiment estimation of the users of the social media according to claim 1, the method further comprising the steps of: after analyzing for a single word, executing the following on two words combinations:
$$2 {\sum }_{i = 1}^{n - 1} P ( {W}_{i} ⋂ {W}_{i + 1} ) = {\sum }_{i = 1}^{n - 1} {C}_{{w}_{i} {w}_{i + 1}} \text{/} {S}_{2}$$
where, S₂ is total two-word appearances as counted in the system.

3. A method for using social media data, from multiple sources, by usage of a modified Bayesian classification to enable sentiment estimation of the users of the social media according to claim 1, the method further comprising the steps of: after analyzing for two words, executing the following for three word combinations:
For a 3 words combination:
$$4 {\sum }_{i = 1}^{n - 2} P ( {W}_{i} ⋂ {W}_{i + 1} ⋂ {W}_{i + 2} ) = {\sum }_{i = 1}^{n - 1} {C}_{{w}_{i} {w}_{i + 1} {w}_{i + 2}} \text{/} {S}_{3} .$$
where the coefficient before the summation is equal 2^{m-1} where m is the words in combination.

4. A method for using social media data, from multiple sources, by usage of a modified Bayesian classification to enable sentiment estimation of the users of the social media, the method comprising the steps of:
a) defining two discrete events, one of the events being the classification of an event, and another event being analysis of the words appearing sequentially to the event in a document;
b) in the analysis of the words appearing sequentially to the event in a document, parsing the incoming message into words list, which includes all punctuation;
c) then collecting word probability in a current message by the following:
$${2}^{m - 1} {\sum }_{i = 1}^{n - m} P ( {W}_{i} ⋂ {W}_{i + 1} ⋂ {W}_{i + 2} … {⋂}_{i + m} ) = {\sum }_{i = 1}^{n - 1} {C}_{{w}_{i} {w}_{i + 1} … {w}_{m}} \text{/} {S}_{m}$$
where, W is the number single word existed in system, and Cᵢ is total count for Wᵢ;
where, S₂ is total word appearances as counted in the system; and
where the coefficient before the summation is equal 2^{m-1} where m is the words in combination.

5. A method for using social media data, from multiple sources, by usage of a modified Bayesian classification to enable sentiment estimation of the users of the social media, the method comprising the steps of:
wherein the coordinators of a message and group are calculated based word frequency occurred in message and group of messages with a similarity coefficient expressed as vectors normalized correlation coefficient,
the similarity coefficient is calculated as vectors normalized correlation coefficients as follows:
$$cos ( g , m ) = \frac{{\sum }_{i = 1}^{n} {g}_{i} {m}_{i}}{\sqrt{{\sum }_{i = 1}^{n} {g}_{i}^{2}} \sqrt{{\sum }_{i = 1}^{n} {m}_{i}^{2}}}$$
wherein gᵢ is i'th word frequency for one of learned categories and mᵢ is the i'th word frequency for current message.
